(19) United States
(12) Patent Application Publication
(10) Pub. No.: US 2026/0262053 A1
(43) Pub. Date: Sep. 3, 2026

(54) UNIFIED TCI STATES FOR MULTI-TRP PDSCH

(71) Applicant: Telefonaktiebolaget LM Ericsson (publ), Stockholm (SE)

(72) Inventors: Shiwei Gao, Nepean (CA); Siva Muruganathan, Stittsville (CA)

(21) Appl. No.: 18/845,746

(22) PCT Filed: Mar. 13, 2023
(86) PCT No.: PCT/IB2023/052414

§ 371 Date: Sep. 10, 2024

Related U.S. Application Data
(60) Provisional application No. 63/318,949, filed on Mar. 11, 2022.

(51) Int. Cl. H04W 72/232; H04W 76/38

(52) U.S. Cl. CPC H04W 72/232; H04W 76/38

(57) ABSTRACT

Systems and methods for unified TCI states for multi-TRP PDSCH are provided. A method performed by a UE includes: receiving an activation command activating a first TCI codepoint with a first unified TCI state or with both first and second unified TCI states, and a second TCI codepoint with up to two unified TCI states; receiving a first DCI indicating the first TCI codepoint in a TCI field; receiving a second DCI scheduling PDSCHs; determining TCI states for reception of the PDSCHs based on the offset, where the TCI states are: the first unified TCI state; the second unified TCI state; both the first and the second unified TCI states; and receiving the PDSCHs according to the determined TCI states. This provides a way to associate a PDSCH reception to common beams or indicated/activated unified TCI states under unified TCI state framework supporting both single TRP and multi-TRP based PDSCH.

### RELATED APPLICATIONS

This application claims the benefit of provisional patent application Ser. No. 63/318,949, filed Mar. 11, 2022, the disclosure of which is hereby incorporated herein by reference in its entirety.

### TECHNICAL FIELD

The present disclosure relates generally to the use of unified Transmission Configuration Indication (TCI) states.

### BACKGROUND

The next generation mobile wireless communication system (5G) or new radio (NR), will support a diverse set of use cases and a diverse set of deployment scenarios. The later includes deployment at both low frequencies (below 6 GHZ) and very high frequencies (up to 10's of GHz).

### NR Frame Structure and Resource Grid

NR uses CP-OFDM (Cyclic Prefix Orthogonal Frequency Division Multiplexing) in both downlink (i.e., from a network node, gNB, or base station, to a user equipment or UE) and uplink (i.e., from UE to gNB). DFT spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel (PDCH), either physical downlink shared channel (PDSCH) or physical uplink shared channel (PUSCH).

Different subcarrier spacing values are supported in NR. The supported subcarrier spacing values (also referred to as different numerologies) are given by Δf=(15×2^{μ}) kHz where μ∈0,1,2,3,4. Δf=15 kHz is the basic subcarrier spacing. The slot durations at different subcarrier spacings are given by

$$\frac{1}{{2}^{u}}$$

ms.

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink and uplink transmissions can be either dynamically scheduled in which the gNB transmits a DL assignment or a uplink grant via downlink control information (DCI) over PDCCH (Physical Downlink Control Channel) to a UE for each PDSCH or PUSCH transmission, or semi-persistent scheduled (SPS) in which one or more DL SPS or UL configured grants (CGs) are semi-statically configured and each can be activated or deactivated by a DCI.

### TCI States and QCL

A Transmission Configuration indication (TCI) state contains Quasi Co-location (QCL) information between the Demodulation Reference Signal (DMRS) of PDSCH and one or two DL reference signals (RS) such as a CSI-RS (Channel State Information Reference Signal) or a SSB (Synchronization Signal Block). Two antenna ports are said to be QCL if certain channel parameters associated with one of the two antenna ports can be inferred from the other antenna port.

The supported QCL information types in NR include:

• ‘QCL-TypeA’: {Doppler shift, Doppler spread, average delay, delay
spread}
• ‘QCL-TypeB’: {Doppler shift, Doppler spread}
• ‘QCL-TypeC’: {Doppler shift, average delay}
• ‘QCL-TypeD’: {Spatial Rx parameter}

A list of TCI states can be RRC configured in a higher layer parameter PDSCH-Config information element (IE) (see 3GPP TS 38.331 section 6.3.2 for details), up to 8 TCI states from the list can be activated with a Medium Access Control (MAC) Control Element (CE). In NR Rel-15, one TCI state is activated by a MAC CE for each TCI codepoint of a TCI field in DCI, where up to eight TCI codepoints can be supported (see 3GPP TS 38.321 section 6.1.3.14 for details). In NR Rel-16, up to two TCI states can be activated by a MAC CE for each TCI codepoint (see 3GPP TS38.321 section 6.1.3.24). For dynamically scheduled PDSCH, one of the TCI codepoints is indicated in the TCI field of the DCI (DCI format 1_1 or DCI format 1_2) scheduling the PDSCH for PDSCH reception. For example, if a SSB or CSI-RS is configured as the QCL-typeD source RS in an activated TCI state indicated to a PDSCH, the same spatial receive filters (i.e., receive beam) for receiving the SSB or CSI-RS would be used by a UE to receive the PDSCH.

Beam Management with Unified TCI Framework

In NR, downlink beam management is performed by conveying spatial QCL (‘Type D’) assumptions to the UE through TCI states.

The NR Rel-15 and Rel-16 beam management framework allows great flexibility for the network to instruct the UE to receive signals from different spatial directions in DL with a cost of large signaling overhead and slow beam switching time. These limitations are particularly noticeable and costly when UE movement is considered. One example is that beam update (or beam switching) using DCI can only be performed for PDSCH, and MAC-CE and/or RRC is required to update the beam for other reference signals/channels, which introduces extra overhead and latency.

Furthermore, in majority of cases, the network transmits to and receive from a UE in the same direction for both data and control. Hence, using separate framework (TCI state respective spatial relations) for different channels/signals complicates the implementations.

In Rel-17, a common beam management framework was introduced to simplify beam management in FR2, in which a common beam represented by a unified TCI state may be activated/indicated to a UE and the common beam is applicable for multiple channels/signals such as PDCCH and PDSCH. In some cases, the common beam may also be applicable to uplink channels such as PUCCH and PUSCH. The common beam framework is also referred to as a unified TCI state framework.

The new framework can be RRC configured in one out two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state can be updated in a similar way as the TCI state update for PDSCH in Rel-15/16, i.e., with one of two alternatives:
Two-stage: RRC signaling is used to configure a number of unified TCI states in higher layer parameter PDSCH-config, and a MAC-CE is used to activate one of the unified TCI states
Three-stage: RRC signaling is used to configure a number of unified TCI states in PDSCH-config, a MAC-CE is used to activate up to 8 unified TCI states, and a 3-bit TCI bitfield in DCI is used to indicate one of the activate unified TCI states

The one activated or indicated unified TCI state will be used in subsequent receptions for both PDCCH and PDSCH until a new unified TCI state is activated or indicated.

The existing DCI formats 1_1 and 1_2 are used for unified TCI state of beam indication/activation, both with and without DL data assignment, i.e., PDSCH. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS (semi-persistent scheduling) PDSCH release with both type-1 and type-2 HARQ-ACK codebook is used, where upon a successful reception of the beam indication/activation DCI, the UE sends an HARQ-ACK.

For DCI-based beam indication the first slot to apply the indicated TCI is at least Y symbols after the last symbol of the acknowledgment of the joint or separate DL/UL beam indication. The Y symbols are configured by the gNB based on UE capability, which is also reported in units of symbols.

### Multi-TRP PDSCH Schemes

In NR Rel-16, PDSCH transmission over two Transmission and Reception Points (TRPs) was introduced, including a non-coherent joint transmission (NC-JT) scheme, two frequency domain multiplexing (FDM) schemes, FDM Scheme A and Scheme B, and two time domain multiplexing (TDM) schemes, i.e., TDM Scheme A and Scheme B.

In NC-JT, a PDSCH in transmitted over two TRPs in a same time and frequency resource with different MIMO layers of the PDSCH transmitted from different TRPs. For example, 2 layers can be transmitted from a first TRP and 1 layer can be transmitted from a second TRP for a total of 3 layers. For NC-JT based PDSCH scheduling, two TCI states are indicated in a TCI codepoint of DCI scheduling the PDSCH. The DMRS ports in a first and second CDM groups are associated with the first and second TCI states, respectively.

In the FDM schemes, different frequency domain resources of a PDSCH are allocated to different TRPs. In FDM scheme A, a single PDSCH is transmitted from two TRPs with part of the PDSCH is sent from one TRP and the rest from the other TRP. In FDM scheme B, a same transport block is repeated across multiple PDSCHs over two TRPs. For FDM based multi-TRP PDSCH scheduling, two TCI states are indicated in a TCI codepoint of DCI scheduling the PDSCH. The DMRS ports in a first and second set of scheduled RBs are associated with the first and second TCI states, respectively.

In the TDM schemes, a same transport block is repeated across multiple PDSCHs in multiple times, each over one of two TRPs. In TDM scheme A, the PDSCHs are repeated two times within a slot, one from each TRP. While in TDM scheme B, the PDSCHs are repeated in consecutive slots, either in a cyclic manner from two TRPs in which the PDSCHs are transmitted alternatively from a first TRP in one slot and a second TRP in the next slots, or in a sequential manner in which PDSCHs are transmitted alternatively from the first and second TRPs every two consecutive slots. For TDM based multi-TRP PDSCH scheduling, two TCI states are indicated in a TCI codepoint of DCI scheduling the PDSCHs. The DMRS ports in a first and second set of PDSCHs are associated with the first and second TCI states, respectively. The first and second set of PDSCHs are determined according to the mapping type, i.e., cyclic or sequential mapping.

An example is shown in FIG. 3, where four PDSCH repetitions are scheduled from two TRPs. In case of cyclic mapping, the 1st and 3rd PDSCHs are associated with the 1st TCI state, and the 2nd and 4th PDSCHs are associated with the 2nd TCI state indicated in the DCI. In case of sequential mapping, the 1st and 2nd PDSCHs are associated with the 1st TCI state, and the 3rd and 4th PDSCHs are associated with the 2nd TCI state indicated in the DCI.

Note that the multi-TRP schemes specified in NR Rel-16 relies on the Rel-15/16 TCI state framework. That is, for each PDSCH or each set of PDSCH repetitions, the TCI states to be applied are indicated by the DCI that schedules the PDSCH or the set of PDSCH repetitions.

Improved systems and methods for unified TCI states are needed.

### SUMMARY

Systems and methods for unified Transmission Configuration Indication (TCI) states for multi-Transmission and Reception Point (TRP) Physical Downlink Shared Channel (PDSCH) are provided. In some embodiments, a method performed by a user equipment for receiving a transmission includes: receiving an activation command activating a first TCI codepoint with a first unified TCI state or with both a first and a second unified TCI states, and a second TCI codepoint with up to two unified TCI states; receiving a first Downlink Control Information (DCI) indicating the first TCI codepoint in a TCI field of the first DCI; receiving a second DCI scheduling one or more PDSCHs wherein there is a time offset between the end of the second DCI and the start of the one or more PDSCHs; determining one or two TCI states for reception of the one or more PDSCHs based at least in part on the time offset, where the one or two TCI states are one or more of: the first unified TCI state; the second unified TCI state; both the first and the second unified TCI states; and receiving the one or more PDSCHs according to the determined TCI state or states. This may provide a simple way to associate a PDSCH reception to one or more common beams or indicated/activated unified TCI states under unified TCI state framework supporting both single TRP and multi-TRP based PDSCH receptions.

A method is proposed to support dynamic switching between sTRP and mTRP based PDSCH reception under unified TCI state framework in which it is envisioned that two TCI states, a first and second TCI states, are always activated.

If a single TCI state is indicated in a TCI codepoint of a DCI scheduling a PDSCH, the PDSCH is a sTRP PDSCH and it is received according to the TCI state indicated in the DCI.

If two TCI states are indicated in a TCI codepoint of a DCI scheduling a PDSCH, the PDSCH is a mTRP PDSCH and it is received according to the first and second TCI states. If the codepoint is different from a previous indicated TCI codepoint activated with the first and second TCI states, the newly indicated two TCI states would be assumed after certain time period to replace the first and second TCI states.

If the time offset between the DCI scheduling the PDSCH and the start of the PDSCH is less than a threshold, the PDSCH is received according to the first TCI state regardless the TCI codepoint indicated in the DCI

If the DCI scheduling the PDSCH doesn't have a TCI field, the PDSCH is received according to the first TCI state.

A method of supporting dynamic switching between sTRP and mTRP based PDSCH reception when two unified TCI states have been activated/indicated. The method comprising: receiving an activation command activating a first TCI codepoint with a first and a second unified TCI state, and a second TCI codepoint with up to two TCI states; receiving a first DCI indicating the first TCI codepoint in a TCI field of the first DCI and sending a HARQ-ACK acknowledging the reception of the first DCI; receiving a second DCI scheduling one or more PDSCH(s), wherein the second DCI is received at least Y symbols after the HARQ-ACK being sent and the second DCI indicating the second TCI codepoint in a TCI field of the second DCI; determining one or two TCI states for reception of the one or more PDSCH(s), where the one or two TCI states are one of: the first TCI state; the second TCI state; both the first and the second TCI states; a third TCI state indicated in the second TCI state; receiving the one or more PDSCH(s) according to the determined TCI state or states.

Wherein the one or more PDSCH(s) is/are received according to the third TCI state if the second TCI codepoint is activated with a single TCI state and the time offset between the end of the second DCI and the start of the PDSCH is greater than or equal to a pre-configured threshold.

Wherein the one or more PDSCH(s) is/are received according to the third TCI state if the third TCI state is the only TCI state activated for the second TCI codepoint wherein the third TCI state is one of the first and second TCI states, and the time offset between the end of the second DCI and the start of the PDSCH is greater than or equal to a pre-configured threshold.

Wherein the one or more PDSCH(s) is/are received according to the first and second TCI states if the second TCI codepoint is activated with two TCI states and the time offset between the end of the second DCI and the start of the PDSCH is greater than or equal to a pre-configured threshold.

Wherein the one or more PDSCH(s) is/are received according to the first TCI state if the time offset between the end of the second DCI and the start of the PDSCH is less than a pre-configured threshold. Where the first DCI is the most recent DCI indicating a TCI codepoint activated with two TCI states prior to the second DCI.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates data scheduling in New Radio (NR) which is typically in slot basis, with a 14-symbol slot, where the first two symbols contain physical downlink control channel (PDCCH) and the rest contains physical shared data channel (PDCH), either physical downlink shared channel (PDSCH) or physical uplink shared channel (PUSCH);

FIG. 2 illustrates a basic NR physical time-frequency resource grid;

FIG. 3 illustrates an example where four PDSCH repetitions are scheduled from two TRPs;

FIG. 4 illustrates a method performed by a user equipment for receiving a transmission, according to some embodiments of the present disclosure;

FIG. 5 illustrates a method performed by a network node for enabling a transmission, according to some embodiments of the present disclosure;

FIG. 6 illustrates an example where two unified Transmission Configuration Indication (TCI) states are activated by a Medium Access Control (MAC) Control Element (CE) for TCI codepoint i and the codepoint is indicated in a TCI field of a DCI, according to some embodiments of the present disclosure;

FIG. 7 illustrates an example where Time Domain Multiplexing (TDM) based multi-Transmission and Reception Point (TRP) PDSCH with cyclic mapping is assumed, according to some embodiments of the present disclosure;

FIG. 8 illustrates an example where the PDSCH(s) is/are received according to the third TCI state, according to some embodiments of the present disclosure;

FIG. 9 illustrates an example where the 2^{nd} TCI codepoint consists of two TCI states, i.e., 3^{rd} and 4^{th} TCI states, which are different from the 1^{st} and 2^{nd} TCI states, according to some embodiments of the present disclosure;

An example is shown in FIG. 10, where the 2nd TCI codepoint consists of a single TCI state, i.e., 3^{rd} TCI states, which are different from the 1^{st} and 2^{nd} TCI states, according to some embodiments of the present disclosure;

FIG. 11 shows an example of a communication system in accordance with some embodiments;

FIG. 12 shows a User Equipment (UE) in accordance with some embodiments;

FIG. 13 shows a network node in accordance with some embodiments;

FIG. 14 is a block diagram of a host, which may be an embodiment of the host of FIG. 11, in accordance with various aspects described herein;

FIG. 15 is a block diagram illustrating a virtualization environment in which functions implemented by some embodiments may be virtualized; and

FIG. 16 shows a communication diagram of a host communicating via a network node with a UE over a partially wireless connection in accordance with some embodiments.

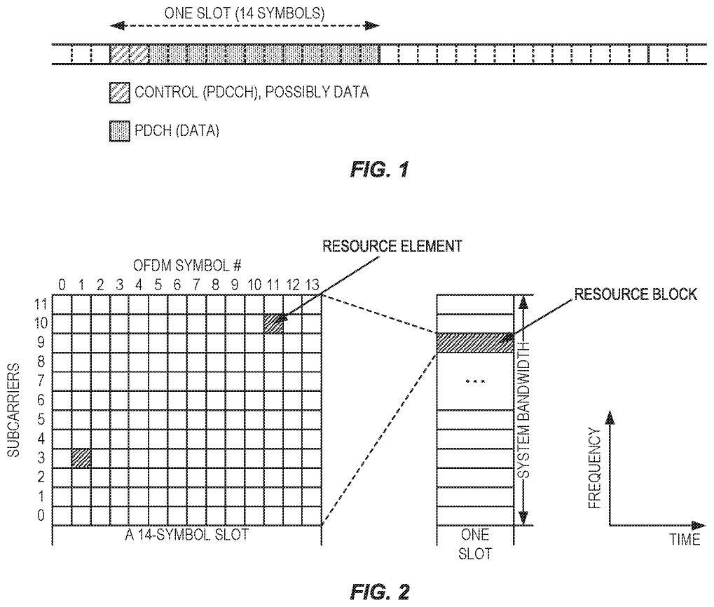

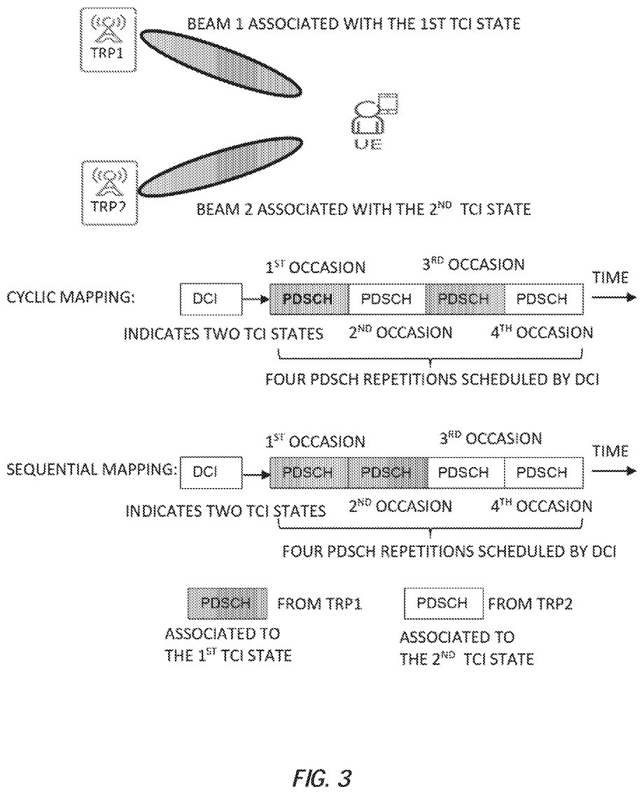

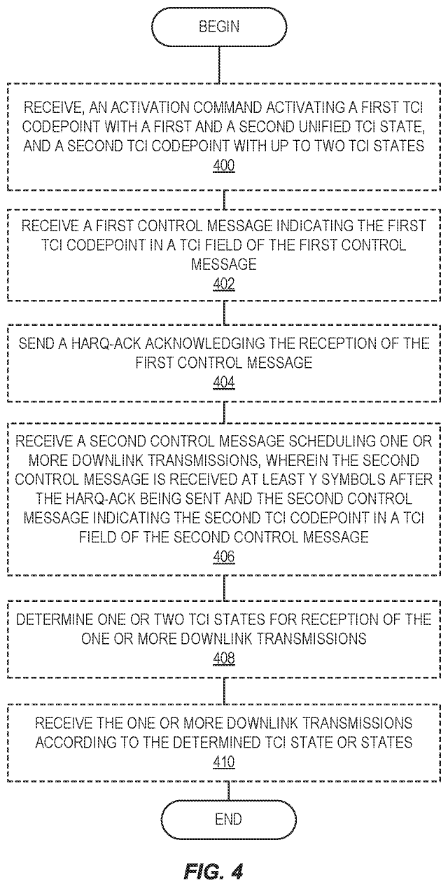

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In the rest of the disclosure, it is assumed that the term Transmission and Reception Point (TRP) or multi-TRP (mTRP) may not be captured in 3GPP specifications. In the various embodiments disclosed, a TRP may be represented by a unified TCI state (which can be, e.g., either a Joint Downlink (DL)/Uplink (UL) Transmission Configuration Indication (TCI) state or a DL-only TCI state).

There currently exist certain challenge(s). In the unified TCI state framework introduced in Rel-17, only a single unified TCI state for each TCI codepoint can be activated by MAC CE or indicated by DCI at each time. Thus, PDSCH reception using the unified TCI state is only supported for PDSCH reception from a single TRP. For the mTRP PDSCH schemes introduced in NR Rel-16, PDSCH reception from multiple TRPs is only supported using the old Rel-15/16 TCI state framework and not supported using Rel-17 unified TCI state-based framework. Hence, how to support PDSCH reception from multiple TRPs using Rel-17 unified TCI based framework is an open problem.

Certain aspects of the disclosure and their embodiments may provide solutions to these or other challenges. A method is proposed to support dynamic switching between sTRP and mTRP based PDSCH reception under unified TCI state framework in which it is envisioned that two TCI states, a first and second TCI states, are always activated.

If a single TCI state is indicated in a TCI codepoint of a DCI scheduling a PDSCH, the PDSCH is a sTRP PDSCH and it is received according to the TCI state indicated in the DCI.

If two TCI states are indicated in a TCI codepoint of a DCI scheduling a PDSCH, the PDSCH is a mTRP PDSCH and it is received according to the first and second TCI states. If the codepoint is different from a previous indicated TCI codepoint activated with the first and second TCI states, the newly indicated two TCI states would be assumed after certain time period to replace the first and second TCI states.

If the time offset between the DCI scheduling the PDSCH and the start of the PDSCH is less than a threshold, the PDSCH is received according to the first TCI state regardless the TCI codepoint indicated in the DCI

If the DCI scheduling the PDSCH doesn't have a TCI field, the PDSCH is received according to the first TCI state.

A method of supporting dynamic switching between sTRP and mTRP based PDSCH reception when two unified TCI states have been activated/indicated. The method comprising: receiving an activation command activating a first TCI codepoint with a first and a second unified TCI state, and a second TCI codepoint with up to two TCI states; receiving a first DCI indicating the first TCI codepoint in a TCI field of the first DCI and sending a HARQ-ACK acknowledging the reception of the first DCI; receiving a second DCI scheduling one or more PDSCH(s), wherein the second DCI is received at least Y symbols after the HARQ-ACK being sent and the second DCI indicating the second TCI codepoint in a TCI field of the second DCI; determining one or two TCI states for reception of the one or more PDSCH(s), where the one or two TCI states are one of: the first TCI state; the second TCI state; both the first and the second TCI states; a third TCI state indicated in the second TCI state; receiving the one or more PDSCH(s) according to the determined TCI state or states.

Wherein the one or more PDSCH(s) is/are received according to the third TCI state if the second TCI codepoint is activated with a single TCI state and the time offset between the end of the second DCI and the start of the PDSCH is greater than or equal to a pre-configured threshold.

Wherein the one or more PDSCH(s) is/are received according to the third TCI state if the third TCI state is the only TCI state activated for the second TCI codepoint wherein the third TCI state is one of the first and second TCI states, and the time offset between the end of the second DCI and the start of the PDSCH is greater than or equal to a pre-configured threshold.

Wherein the one or more PDSCH(s) is/are received according to the first and second TCI states if the second TCI codepoint is activated with two TCI states and the time offset between the end of the second DCI and the start of the PDSCH is greater than or equal to a pre-configured threshold.

Wherein the one or more PDSCH(s) is/are received according to the first TCI state if the time offset between the end of the second DCI and the start of the PDSCH is less than a pre-configured threshold

Where the first DCI is the most recent DCI indicating a TCI codepoint activated with two TCI states prior to the second DCI.

Certain embodiments may provide one or more of the following technical advantages. The method provides a simple way to associate a PDSCH reception to one or more common beams or indicated/activated unified TCI states under unified TCI state framework supporting both single TRP and multi-TRP based PDSCH receptions.

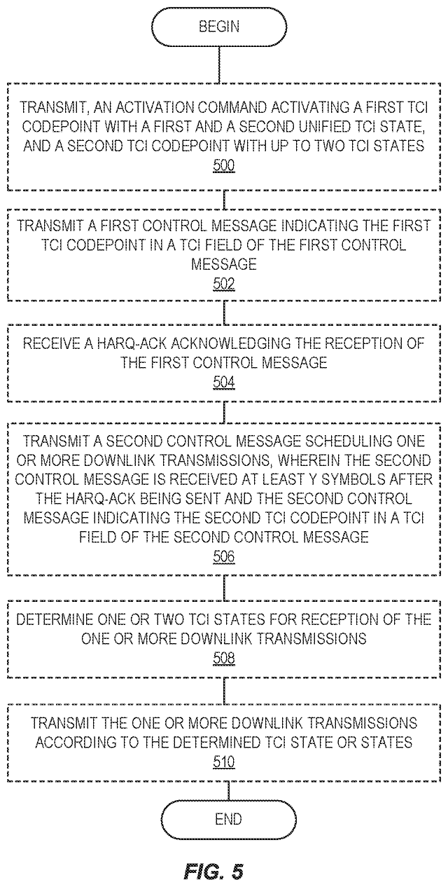

FIG. 4 illustrates a method performed by a user equipment for receiving a transmission, according to some embodiments of the present disclosure. The method includes one or more of: receiving (step 400) an activation command activating a first TCI codepoint with a first and a second unified TCI state, and a second TCI codepoint with up to two TCI states; receiving (step 402) a first control message indicating the first TCI codepoint in a TCI field of the first control message; sending (step 404) a HARQ-ACK acknowledging the reception of the first control message; receiving (step 406) a second control message scheduling one or more downlink transmissions, wherein the second control message is received at least Y symbols after the HARQ-ACK being sent and the second control message indicating the second TCI codepoint in a TCI field of the second control message; determining (step 408) one or two TCI states for reception of the one or more downlink transmissions, where the one or two TCI states are one or more of: the first TCI state; the second TCI state; both the first and the second TCI states; and a third TCI state indicated in the second TCI state; and receiving (step 410) the one or more downlink transmissions according to the determined TCI state or states.

FIG. 5 illustrates a method performed by a network node for enabling a transmission, according to some embodiments of the present disclosure. The method includes one or more of: transmitting (step 500), to a wireless device, an activation command activating a first TCI codepoint with a first and a second unified TCI state, and a second TCI codepoint with up to two TCI states; transmitting (step 502), to the wireless device, a first control message indicating the first TCI codepoint in a TCI field of the first control message; receiving (step 504), from the wireless device, a HARQ-ACK acknowledging the reception of the first control message; transmitting (step 506) a second control message scheduling one or more downlink transmissions, wherein the second control message is received at least Y symbols after the HARQ-ACK being sent and the second control message indicating the second TCI codepoint in a TCI field of the second control message; determining (step 508) one or two TCI states for reception of the one or more downlink transmissions, where the one or two TCI states are one or more of: the first TCI state; the second TCI state; both the first and the second TCI states; and a third TCI state indicated in the second TCI state; and transmitting (step 510) the one or more downlink transmissions according to the determined TCI state or states.

For mTRP based DL reception with unified TCI states, more than one unified TCI state need to be indicated/activated using a combination of RRC signalling, MAC CE signaling and DCI indication comprising one or more of the following steps:
Step 1: A UE is RRC configured with a list of unified TCI states, each associated with a beam or spatial filter, where N_{max,TCI} is the maximum number of unified TCI states that can be configured:

TCI state 0
TCI state 1
...
TCI state N_{max,TCI} − 1

Step 2: MAC CE activates multiple TCI states out of the list of unified TCI states for each TCI codepoint in a TCI field in DCI, where M is the number of TCI codepoints, Lᵢ is the number of activated TCI states for the i^{th} TCI codepoint, and k_{i,j}∈

{0,1, ..., N_{max,TCI} − 1}:
{TCI state k_{0,1}, TCI state k_{0,2}, ..., TCI state k_{0,L}_{₀}, } for TCI codepoint 0
{TCI state k_{1,1}, TCI state k_{1,2}, ..., TCI state k_{1,L}_{₁}, } for TCI codepoint 1
...
{TCI state k_{M-1,1}, TCI state k_{M-1,2}, ..., TCI state k_{M-1,L}_{_{M−1}} } for
TCI codepoint M−1

Step 3: One of the TCI codepoints is signaled to the UE via a DCI. The corresponding TCI states are to be used for subsequent DL transmissions after a certain time period as described in step 4.
Step 4: UE sends a HARQ-ACK to acknowledge the reception of the DCI. After a certain time period (e.g., Y symbols), the TCI states associated with the TCI codepoint are assumed for certain DL channels or signals

Steps 3 & 4 above may be repeated by signaling a different TCI codepoint by subsequent DCIs if a new set of activated TCI states is needed due to, for example, UE movement. Steps 2, 3, & 4 may be repeated if new TCI states need to be activated.

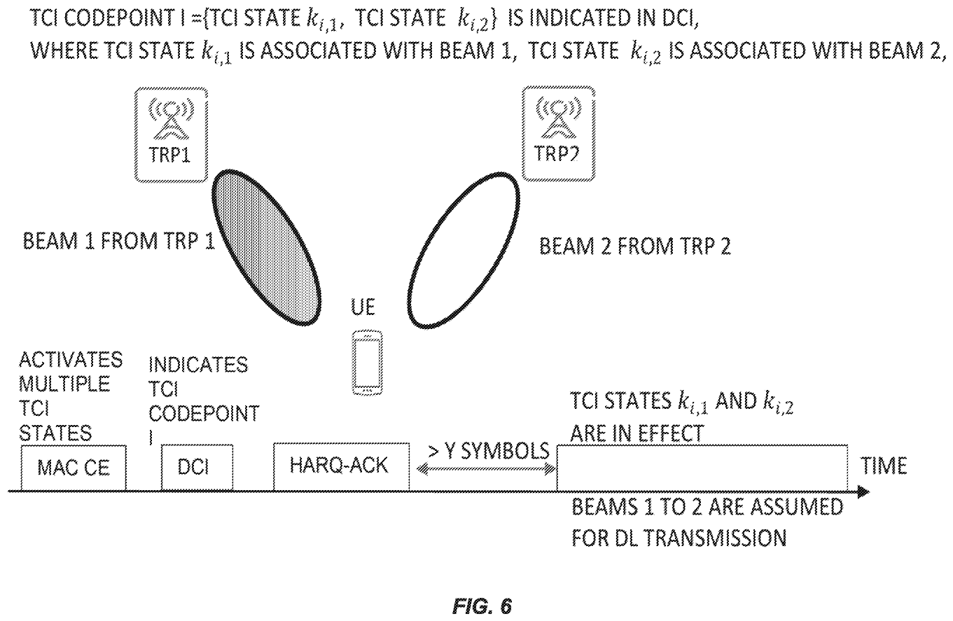

An example is illustrated in FIG. 6 below, where two unified TCI states are activated by a MAC CE for TCI codepoint i and the codepoint is indicated in a TCI field of a DCI. The two TCI states associated with the TCI codepoint take effect after Y symbols after the HARQ-ACK is transmitted. Each of the two TCI states is associated with a common beam from each of two TRPs.

In the following, unified TCI states associated with the indicated TCI codepoint in DCI are referred to as activated/indicated unified TCI states. The terms of activated/indicated unified TCI states, activated unified TCI states, indicated unified TCI states, indicated TCI states, and common beams are used interchangeably.

In one embodiment, when the UE is configured by RRC with one of the NR Rel-16 multi-TRP PDSCH schemes, i.e., NC-JT, FDM or TDM scheme A or Scheme B, and receives a first TCI codepoint in a first DCI indicating a first and a second unified TCI states, and a second DCI scheduling a PDSCH after the first and second unified TCI states being taken into effect, the UE determines one of or both of the two TCI states for reception of the PDSCH.

If the time offset between the end of the second DCI and the start of the PDSCH(s) is equal to or larger than a pre-configured threshold, and:

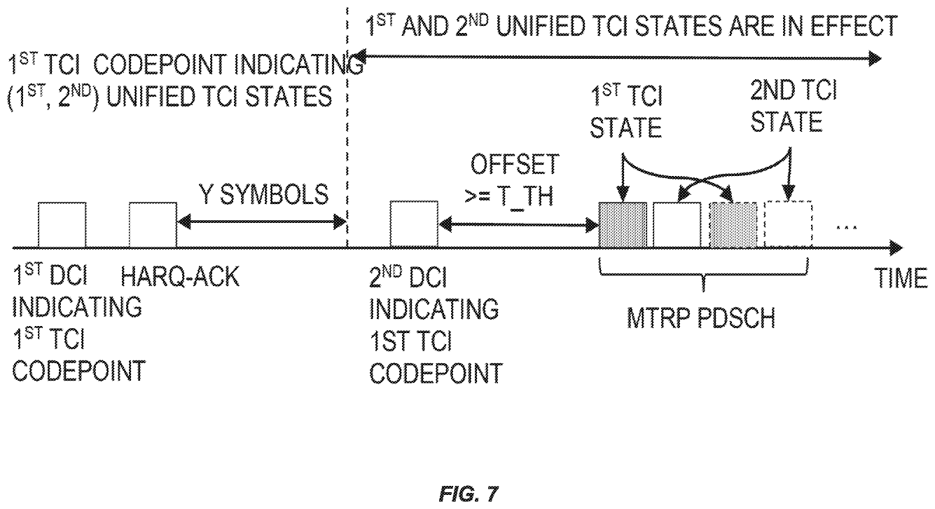

If the second DCI indicates a second TCI codepoint which is the same as the first TCI codepoint, the PDSCH(s) is/are received according to the first and second unified TCI states. An example is shown in FIG. 7, where TDM based multi-TRP PDSCH with cyclic mapping is assumed.

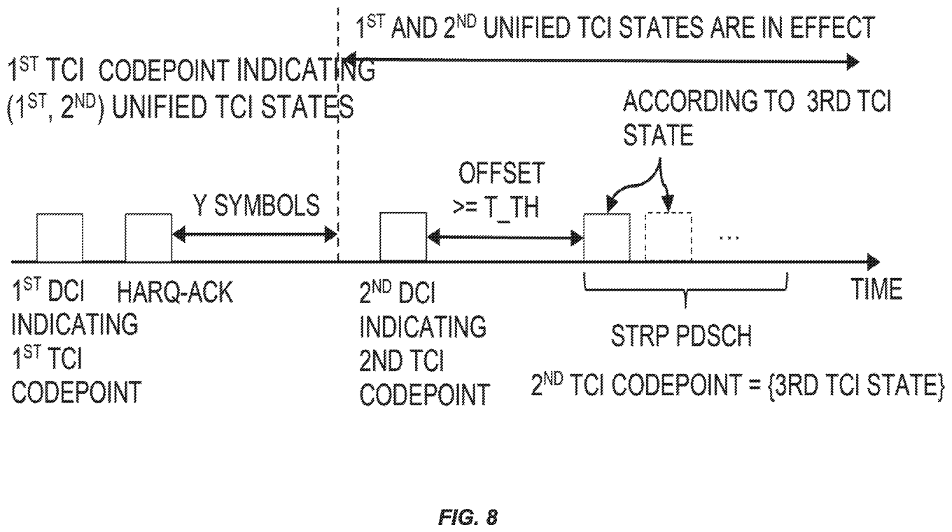

If the second TCI codepoint is different than the first TCI codepoint and if the second TCI codepoint contains a single third TCI state which is either one of the first and second TCI sates or a different TCI state, the PDSCH(s) is/are received according to the third TCI state. An example is shown in FIG. 8.

In an optional embodiment, even if the third TCI state is different from any one of the first and second TCI states, the first and second TCI states remain in effect after the second DCI. In other words, the second DCI does not trigger a TCI state change other than for the scheduled PDSCH.

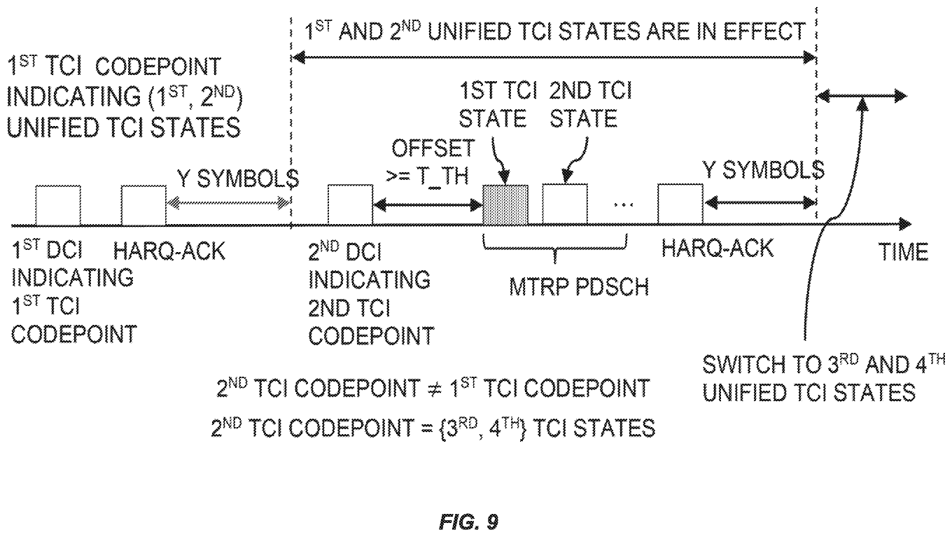

If the second TCI codepoint is different than the first TCI codepoint and if the second TCI codepoint contains two TCI states, the PDSCH(s) is/are received according to the first and second unified TCI states, and the unified TCI states contained in the second TCI codepoint would take effect Y symbols after an HARQ-ACK associated with the PDSCH being sent. An example is shown in FIG. 9, where the 2nd TCI codepoint consists of two TCI states, i.e., 3^{rd} and 4^{th} TCI states, which are different from the 1^{st} and 2^{nd} TCI states.

If the time offset between the end of the second DCI and the start of the PDSCH is smaller than the pre-configured threshold, the PDSCH(s) is/are always received according to the first unified TCI state regardless the second TCI codepoint. In another embodiment, when the time offset between the end of the second DCI and the start of the PDSCH is smaller than the pre-configured threshold, the PDSCH(s) is/are always received according to the unified TCI state that has a lower identifier (e.g., a lower TCI State ID) among the two unified TCI states. For instance, if first unified TCI state has TCI state ID #1, second unified TCI state has TCI state ID #2, and TCI state ID #1<TCI state ID #2, then the PDSCH(s) is/are received according the first unified TCI state.

In an alternative embodiment, if the time offset between the end of the second DCI and the start of the PDSCH is smaller than the pre-configured threshold, the PDSCH(s) is/are always received according to the second unified TCI state regardless the second TCI codepoint. In another alternative embodiment, when the time offset between the end of the second DCI and the start of the PDSCH is smaller than the pre-configured threshold, the PDSCH(s) is/are received according to the unified TCI state that has a larger identifier (e.g., a larger TCI State ID) among the two unified TCI states. For instance, if first unified TCI state has TCI state ID #1, second unified TCI state has TCI state ID #2, and TCI state ID #1<TCI state ID #2, then the PDSCH(s) is/are received according the second unified TCI state.

If the second DCI does not contain a TCI field, the PDSCH(s) is/are always received according to the first unified TCI state.

If the second TCI codepoint is different than the first TCI codepoint and if the second TCI codepoint contains one TCI state that is different from the first unified TCI state and the second unified TCI state, the PDSCH(s) is/are received according to the first and second unified TCI states, and the unified TCI state contained in the second TCI codepoint would take effect Y symbols after an HARQ-ACK associated with the PDSCH being sent. An example is shown in FIG. 10, where the 2nd TCI codepoint consists of a single TCI state, i.e., 3rd TCI states, which are different from the 1st and 2nd TCI states.

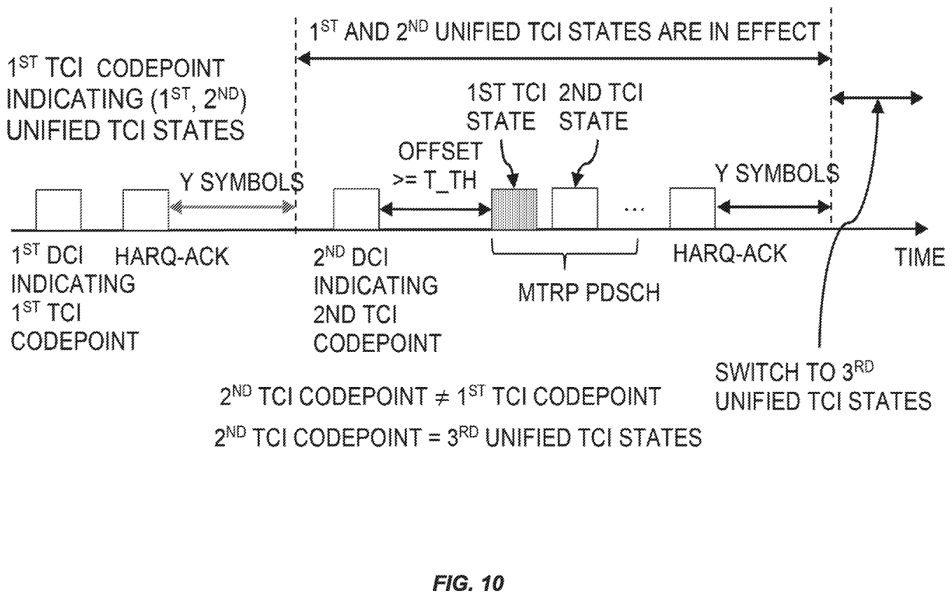

FIG. 11 shows an example of a communication system 1100 in accordance with some embodiments. In the example, the communication system 1100 includes a telecommunication network 1102 that includes an access network 1104, such as a Radio Access Network (RAN), and a core network 1106, which includes one or more core network nodes 1108. The access network 1104 includes one or more access network nodes, such as network nodes 1110A and 1110B (one or more of which may be generally referred to as network nodes 1110), or any other similar Third Generation Partnership Project (3GPP) access node or non-3GPP Access Point (AP). The network nodes 1110 facilitate direct or indirect connection of User Equipment (UE), such as by connecting UEs 1112A, 1112B, 1112C, and 1112D (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102 and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system 1100 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1102 is a cellular network that implements 3GPP standardized features. Accordingly, the telecommunication network 1102 may support network slicing to provide different logical networks to different devices that are connected to the telecommunication network 1102. For example, the telecommunication network 1102 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1114 communicates with the access network 1104 to facilitate indirect communication between one or more UEs (e.g., UE 1112C and/or 1112D) and network nodes (e.g., network node 1110B). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a Virtual Reality (VR) headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110B. The hub 1114 may also allow for a different communication scheme and/or schedule between the hub 1114 and UEs (e.g., UE 1112C and/or 1112D), and between the hub 1114 and the core network 1106. In other examples, the hub 1114 is connected to the core network 1106 and/or one or more UEs via a wired connection. Moreover, the hub 1114 may be configured to connect to a Machine-to-Machine (M2M) service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110B. In other embodiments, the hub 1114 may be a non-dedicated hub—that is, a device which is capable of operating to route communications between the UEs and the network node 1110B, but which is additionally capable of operating as a communication start and/or end point for certain data channels.

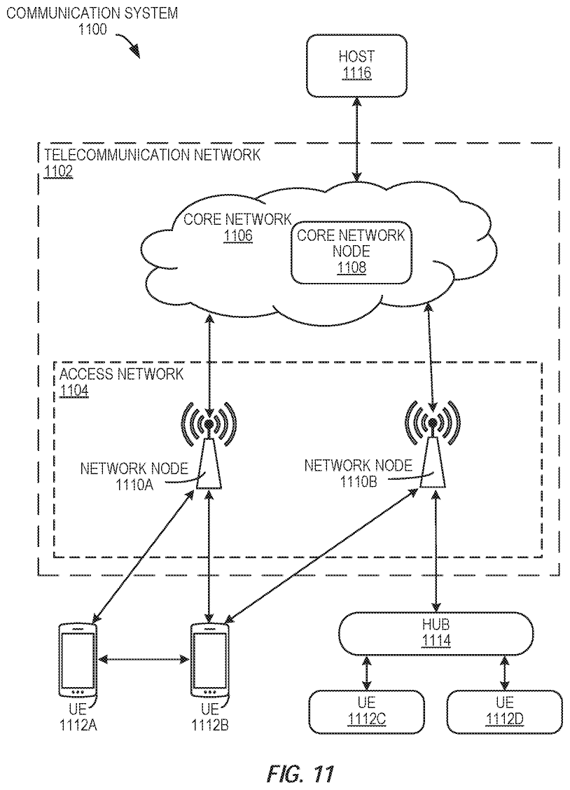

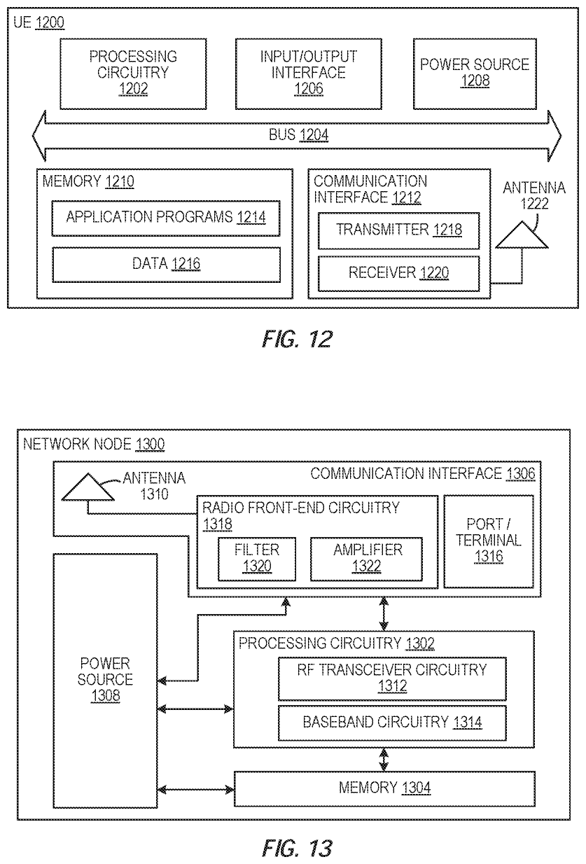

FIG. 12 shows a UE 1200 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1202 may include multiple Central Processing Units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging the power source 1208. Power circuitry may perform any formatting, converting, or other modification to the power from the power source 1208 to make the power suitable for the respective components of the UE 1200 to which power is supplied.

The memory 1210 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1210 may allow the UE 1200 to access instructions, application programs, and the like stored on transitory or non-transitory memory media, to off-load data, or to upload data. An article of manufacture, such as one utilizing a communication system, may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., the antenna 1222) and may share circuit components, software, or firmware, or alternatively be implemented separately.

In the illustrated embodiment, communication functions of the communication interface 1212 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1212, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 13 shows a network node 1300 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, memory 1304, a communication interface 1306, and a power source 1308. The network node 1300 may be composed of multiple physically separate components (e.g., a Node B component and an RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1300 may be configured to support multiple RATs. In such embodiments, some components may be duplicated (e.g., separate memory 1304 for different RATs) and some components may be reused (e.g., an antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1300.

The processing circuitry 1302 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1300 components, such as the memory 1304, to provide network node 1300 functionality.

In some embodiments, the processing circuitry 1302 includes a System on a Chip (SOC). In some embodiments, the processing circuitry 1302 includes one or more of Radio Frequency (RF) transceiver circuitry 1312 and baseband processing circuitry 1314. In some embodiments, the RF transceiver circuitry 1312 and the baseband processing circuitry 1314 may be on separate chips (or sets of chips), boards, or units, such as radio units and digital units. In alternative embodiments, part or all of the RF transceiver circuitry 1312 and the baseband processing circuitry 1314 may be on the same chip or set of chips, boards, or units.

The memory 1304 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and the memory 1304 are integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. The radio front-end circuitry 1318 comprises filters 1320 and amplifiers 1322. The radio front-end circuitry 1318 may be connected to the antenna 1310 and the processing circuitry 1302. The radio front-end circuitry 1318 may be configured to condition signals communicated between the antenna 1310 and the processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of the filters 1320 and/or the amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface 1306 may comprise different components and/or different combinations of components.

In certain alternative embodiments, the network node 1300 does not include separate radio front-end circuitry 1318; instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes the one or more ports or terminals 1316, the radio front-end circuitry 1318, and the RF transceiver circuitry 1312 as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, the communication interface 1306, and/or the processing circuitry 1302 may be configured to perform any receiving operations and/or certain obtaining operations described herein as being performed by the network node 1300. Any information, data, and/or signals may be received from a UE, another network node, and/or any other network equipment. Similarly, the antenna 1310, the communication interface 1306, and/or the processing circuitry 1302 may be configured to perform any transmitting operations described herein as being performed by the network node 1300. Any information, data, and/or signals may be transmitted to a UE, another network node, and/or any other network equipment.

The power source 1308 provides power to the various components of the network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid or an electricity outlet) via input circuitry or an interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

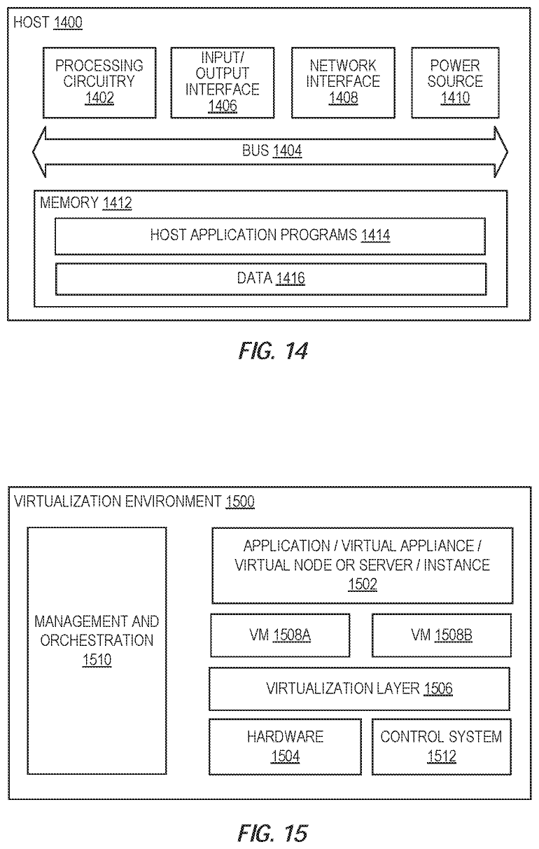

FIG. 14 is a block diagram of a host 1400, which may be an embodiment of the host 1116 of FIG. 11, in accordance with various aspects described herein. As used herein, the host 1400 may be or comprise various combinations of hardware and/or software including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and memory 1412. Other components may be included in other embodiments. Features of these components may be substantially similar to those described with respect to the devices of previous figures, such as FIGS. 12 and 13, such that the descriptions thereof are generally applicable to the corresponding components of the host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for Over-The-Top (OTT) services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or VM Monitors (VMMs)), provide VMs 1508A and 1508B (one or more of which may be generally referred to as VMs 1508), and/or perform any of the functions, features, and/or benefits described in relation with some embodiments described herein. The virtualization layer 1506 may present a virtual operating platform that appears like networking hardware to the VMs 1508.

The VMs 1508 comprise virtual processing, virtual memory, virtual networking, or interface and virtual storage, and may be run by a corresponding virtualization layer 1506. Different embodiments of the instance of a virtual appliance 1502 may be implemented on one or more of the VMs 1508, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1508 may be a software implementation of a physical machine that runs programs as if they were executing on a physical, non-virtualized machine. Each of the VMs 1508, and that part of the hardware 1504 that executes that VM, be it hardware dedicated to that VM and/or hardware shared by that VM with others of the VMs 1508, forms separate virtual network elements. Still in the context of NFV, a virtual network function is responsible for handling specific network functions that run in one or more VMs 1508 on top of the hardware 1504 and corresponds to the application 1502.

The hardware 1504 may be implemented in a standalone network node with generic or specific components. The hardware 1504 may implement some functions via virtualization. Alternatively, the hardware 1504 may be part of a larger cluster of hardware (e.g., such as in a data center or CPE) where many hardware nodes work together and are managed via management and orchestration 1510, which, among others, oversees lifecycle management of the applications 1502. In some embodiments, the hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1512 which may alternatively be used for communication between hardware nodes and radio units.

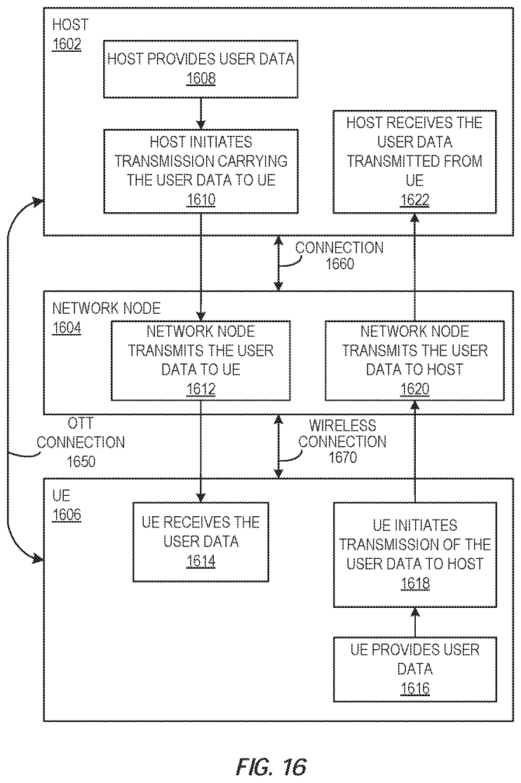

FIG. 16 shows a communication diagram of a host 1602 communicating via a network node 1604 with a UE 1606 over a partially wireless connection in accordance with some embodiments. Example implementations, in accordance with various embodiments, of the UE (such as the UE 1112A of FIG. 11 and/or the UE 1200 of FIG. 12), the network node (such as the network node 1110A of FIG. 11 and/or the network node 1300 of FIG. 13), and the host (such as the host 1116 of FIG. 11 and/or the host 1400 of FIG. 14) discussed in the preceding paragraphs will now be described with reference to FIG. 16.

Like the host 1400, embodiments of the host 1602 include hardware, such as a communication interface, processing circuitry, and memory. The host 1602 also includes software, which is stored in or is accessible by the host 1602 and executable by the processing circuitry. The software includes a host application that may be operable to provide a service to a remote user, such as the UE 1606 connecting via an OTT connection 1650 extending between the UE 1606 and the host 1602. In providing the service to the remote user, a host application may provide user data which is transmitted using the OTT connection 1650.

The network node 1604 includes hardware enabling it to communicate with the host 1602 and the UE 1606 via a connection 1660. The connection 1660 may be direct or pass through a core network (like the core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by the UE 1606 and executable by the UE's processing circuitry. The software includes a client application, such as a web browser or operator-specific “app” that may be operable to provide a service to a human or non-human user via the UE 1606 with the support of the host 1602. In the host 1602, an executing host application may communicate with the executing client application via the OTT connection 1650 terminating at the UE 1606 and the host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via the connection 1660 between the host 1602 and the network node 1604 and via a wireless connection 1670 between the network node 1604 and the UE 1606 to provide the connection between the host 1602 and the UE 1606. The connection 1660 and the wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604 in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR, or AR which it can broadcast, multicast, or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and the UE 1606 in response to variations in the measurement results. The measurement procedure and/or the network functionality for reconfiguring the OTT connection 1650 may be implemented in software and hardware of the host 1602 and/or the UE 1606. In some embodiments, sensors (not shown) may be deployed in or in association with other devices through which the OTT connection 1650 passes; the sensors may participate in the measurement procedure by supplying values of the monitored quantities exemplified above, or by supplying values of other physical quantities from which software may compute or estimate the monitored quantities. The reconfiguring of the OTT connection 1650 may include message format, retransmission settings, preferred routing, etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, and the like by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### EMBODIMENTS

### Group A Embodiments

Embodiment 1: A method performed by a user equipment for receiving a transmission, the method comprising one or more of: a. receiving (400) an activation command activating a first Transmission Configuration indication, TCI, codepoint with a first and a second unified TCI state, and a second TCI codepoint with up to two TCI states; b. receiving (402) a first control message indicating the first TCI codepoint in a TCI field of the first control message; c. sending (404) a Hybrid Automatic Repeat Request-Acknowledgement, HARQ-ACK, acknowledging the reception of the first control message; d. receiving (406) a second control message scheduling one or more downlink transmissions, wherein the second control message is received at least Y symbols after the HARQ-ACK being sent and the second control message indicating the second TCI codepoint in a TCI field of the second control message; e. determining (408) one or two TCI states for reception of the one or more downlink transmissions, where the one or two TCI states are one or more of: the first TCI state; the second TCI state; both the first and the second TCI states; and a third TCI state indicated in the second TCI state; and f. receiving (410) the one or more downlink transmissions according to the determined TCI state or states.
Embodiment 2: The method of any of the previous embodiments wherein the one or more downlink transmissions comprise one or more Physical Downlink Shared Channel, PDSCH(s).
Embodiment 3: The method of any of the previous embodiments wherein one or more of the first control message comprises a first Downlink Control Information, DCI; and the second control message comprises a second DCI.
Embodiment 4: The method of any of the previous embodiments further comprising: being configured, via RRC, with a list of unified TCI states, each associated with a beam or spatial filter.
Embodiment 5: The method of any of the previous embodiments further comprising: receiving activation, via MAC CE, of multiple TCI states out of the list of unified TCI states for each TCI codepoint in a TCI field in DCI.
Embodiment 6: The method of any of the previous embodiments wherein the one or more PDSCH(s) are received according to the third TCI state if the second TCI codepoint is activated with a single TCI state and the time offset between the end of the second DCI and the start of the PDSCH is greater than or equal to a pre-configured threshold.
Embodiment 7: The method of any of the previous embodiments wherein the one or more PDSCH(s) are received according to the third TCI state if the third TCI state is the only TCI state activated for the second TCI codepoint wherein the third TCI state is one of the first and second TCI states, and the time offset between the end of the second DCI and the start of the PDSCH is greater than or equal to a pre-configured threshold.
Embodiment 8: The method of any of the previous embodiments wherein the one or more PDSCH(s) are received according to the first and second TCI states if the second TCI codepoint is activated with two TCI states and the time offset between the end of the second DCI and the start of the PDSCH is greater than or equal to a pre-configured threshold.
Embodiment 9: The method of any of the previous embodiments wherein the one or more PDSCH(s) are received according to the first TCI state if the time offset between the end of the second DCI and the start of the PDSCH is less than a pre-configured threshold.
Embodiment 10: The method of any of the previous embodiments wherein the first DCI is the most recent DCI indicating a TCI codepoint activated with two TCI states prior to the second DCI.
Embodiment 11: The method of any of the previous embodiments, further comprising: providing user data; and forwarding the user data to a host via the transmission to the network node.

### Group B Embodiments

Embodiment 12: A method performed by a network node for enabling a transmission, the method comprising one or more of: a. transmitting (500), to a wireless device, an activation command activating a first Transmission Configuration indication, TCI, codepoint with a first and a second unified TCI state, and a second TCI codepoint with up to two TCI states; b. transmitting (502), to the wireless device, a first control message indicating the first TCI codepoint in a TCI field of the first control message; c. receiving (504), from the wireless device, a Hybrid Automatic Repeat Request-Acknowledgement, HARQ-ACK, acknowledging the reception of the first control message; d. transmitting (506) a second control message scheduling one or more downlink transmissions, wherein the second control message is received at least Y symbols after the HARQ-ACK being sent and the second control message indicating the second TCI codepoint in a TCI field of the second control message; e. determining (508) one or two TCI states for reception of the one or more downlink transmissions, where the one or two TCI states are one or more of: the first TCI state; the second TCI state; both the first and the second TCI states; and a third TCI state indicated in the second TCI state; f. transmitting (510) the one or more downlink transmissions according to the determined TCI state or states.
Embodiment 13: The method of any of the previous embodiments wherein the one or more downlink transmissions comprise one or more Physical Downlink Shared Channel, PDSCH(s).
Embodiment 14: The method of any of the previous embodiments wherein one or more of the first control message comprises a first Downlink Control Information, DCI; and the second control message comprises a second DCI.
Embodiment 15: The method of any of the previous embodiments further comprising: configuring the wireless device, via RRC, with a list of unified TCI states, each associated with a beam or spatial filter.
Embodiment 16: The method of any of the previous embodiments further comprising: transmitting activation, via MAC CE, of multiple TCI states out of the list of unified TCI states for each TCI codepoint in a TCI field in DCI.
Embodiment 17: The method of any of the previous embodiments wherein the one or more PDSCH(s) are transmitted according to the third TCI state if the second TCI codepoint is activated with a single TCI state and the time offset between the end of the second DCI and the start of the PDSCH is greater than or equal to a pre-configured threshold.
Embodiment 18: The method of any of the previous embodiments wherein the one or more PDSCH(s) are transmitted according to the third TCI state if the third TCI state is the only TCI state activated for the second TCI codepoint wherein the third TCI state is one of the first and second TCI states, and the time offset between the end of the second DCI and the start of the PDSCH is greater than or equal to a pre-configured threshold.
Embodiment 19: The method of any of the previous embodiments wherein the one or more PDSCH(s) are transmitted according to the first and second TCI states if the second TCI codepoint is activated with two TCI states and the time offset between the end of the second DCI and the start of the PDSCH is greater than or equal to a pre-configured threshold.
Embodiment 20: The method of any of the previous embodiments wherein the one or more PDSCH(s) are transmitted according to the first TCI state if the time offset between the end of the second DCI and the start of the PDSCH is less than a pre-configured threshold.
Embodiment 21: The method of any of the previous embodiments wherein the first DCI is the most recent DCI indicating a TCI codepoint activated with two TCI states prior to the second DCI.
Embodiment 22: The method of any of the previous embodiments, further comprising: obtaining user data; and forwarding the user data to a host or a user equipment. Group C Embodiments
Embodiment 23: A user equipment for receiving a transmission, comprising: processing circuitry configured to perform any of the steps of any of the Group A embodiments; and power supply circuitry configured to supply power to the processing circuitry.
Embodiment 24: A network node for enabling a transmission, the network node comprising: processing circuitry configured to perform any of the steps of any of the Group B embodiments; power supply circuitry configured to supply power to the processing circuitry.
Embodiment 25: A user equipment (UE) for receiving a transmission, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 26: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.
Embodiment 27: The host of the previous embodiment, wherein the cellular network further includes a network node configured to communicate with the UE to transmit the user data to the UE from the host.
Embodiment 28: The host of the previous 2 embodiments, wherein: the processing circuitry of the host is configured to execute a host application, thereby providing the user data; and the host application is configured to interact with a client application executing on the UE, the client application being associated with the host application.
Embodiment 29: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
Embodiment 30: The method of the previous embodiment, further comprising: at the host, executing a host application associated with a client application executing on the UE to receive the user data from the UE.
Embodiment 31: The method of the previous embodiment, further comprising: at the host, transmitting input data to the client application executing on the UE, the input data being provided by executing the host application, wherein the user data is provided by the client application in response to the input data from the host application.
Embodiment 32: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
Embodiment 33: The host of the previous embodiment, wherein the cellular network further includes a network node configured to communicate with the UE to transmit the user data from the UE to the host.
Embodiment 34: The host of the previous 2 embodiments, wherein: the processing circuitry of the host is configured to execute a host application, thereby providing the user data; and the host application is configured to interact with a client application executing on the UE, the client application being associated with the host application.
Embodiment 35: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.
Embodiment 36: The method of the previous embodiment, further comprising: at the host, executing a host application associated with a client application executing on the UE to receive the user data from the UE.
Embodiment 37: The method of the previous embodiment, further comprising: at the host, transmitting input data to the client application executing on the UE, the input data being provided by executing the host application, wherein the user data is provided by the client application in response to the input data from the host application.
Embodiment 38: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
Embodiment 39: The host of the previous embodiment, wherein: the processing circuitry of the host is configured to execute a host application that provides the user data; and the UE comprises processing circuitry configured to execute a client application associated with the host application to receive the transmission of user data from the host.
Embodiment 40: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.
Embodiment 41: The method of the previous embodiment, further comprising, at the network node, transmitting the user data provided by the host for the UE.
Embodiment 42: The method of any of the previous 2 embodiments, wherein the user data is provided at the host by executing a host application that interacts with a client application executing on the UE, the client application being associated with the host application.
Embodiment 43: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
Embodiment 44: The communication system of the previous embodiment, further comprising: the network node; and/or the user equipment.
Embodiment 45: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
Embodiment 46: The host of the previous 2 embodiments, wherein: the processing circuitry of the host is configured to execute a host application, thereby providing the user data; and the host application is configured to interact with a client application executing on the UE, the client application being associated with the host application.
Embodiment 47: The host of the any of the previous 2 embodiments, wherein the initiating receipt of the user data comprises requesting the user data.
Embodiment 48: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
Embodiment 49: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation.
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DCI Downlink Control Information
DN Data Network.
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HARQ-ACK Hybrid Automatic Repeat Request-Acknowledgement
HSS Home Subscriber Server
IoT Internet of Things
IP Internet Protocol
LTE Long Term Evolution
MME Mobility Management Entity
MTC Machine Type Communication.
NEF Network Exposure Function
NF Network Function
NR New Radio
NRF Network Function Repository Function
NSSF Network Slice Selection Function
OTT Over-the-Top
PC Personal Computer
PCF Policy Control Function
PDSCH Physical Downlink Shared Channel
P-GW Packet Data Network Gateway
QoS Quality of Service
RAM Random Access Memory
RAN Radio Access Network.
ROM Read Only Memory
RRH Remote Radio Head
RTT Round Trip Time
SCEF Service Capability Exposure Function
SMF Session Management Function
TCI Transmission Configuration Indication
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a user equipment for receiving a transmission from a network node, the method comprising:
receiving an activation command activating a first Transmission Configuration Indication, TCI, codepoint with a first unified TCI state or with both a first and a second unified TCI states, and a second TCI codepoint with up to two unified TCI states;
receiving a first Downlink Control Information, DCI, indicating the first TCI codepoint in a TCI field of the first DCI;
receiving a second DCI scheduling one or more Physical Downlink Shared Channels, PDSCHs, wherein there is a time offset between the end of the second DCI and the start of the one or more PDSCHs;
determining one or two TCI states for reception of the one or more PDSCHs based at least in part on the time offset, where the one or two TCI states are one or more of: the first unified TCI state; the second unified TCI state; both the first and the second unified TCI states; and
receiving the one or more PDSCHs according to the determined TCI state or states.

2-30. (canceled)
